(19) United States
(12) Patent Application Publication
(10) Pub. No.: US 2025/0018368 A1
(43) Pub. Date: Jan. 16, 2025

(54) HYDROPHILIC FOAM FOR RETENTION OF ORGANIC AND INORGANIC COMPOUNDS, PRODUCTION PROCESS AND USES THEREOF

(71) Applicant: CNPEM - CENTRO NACIONAL DE PESQUISA EM ENERGIA E MATERIAIS, Campinas (BR)

(72) Inventors: Marcos Vinicius LOREVICE, Campinas (BR); Rubia FIGUEREDO GOUVEIA, Campinas (BR)

(21) Appl. No.: 18/704,716

(22) PCT Filed: Oct. 25, 2022
(86) PCT No.: PCT/BR2022/050410

§ 371 Date: Apr. 25, 2024

(30) Foreign Application Priority Data
Oct. 25, 2021 (BR) 1020210213299
Oct. 25, 2022 (BR) 1020220216037

(51) Int. Cl. B01J 20/24; B01J 20/28; B01J 20/30; C02F 1/28; C02F 101/20; C02F 101/30

(52) U.S. Cl. CPC B01J 20/24; B01J 20/28026; B01J 20/28045; B01J 20/3042; B01J 20/305; C02F 1/286; C02F 2101/20; C02F 2101/301; C02F 2101/308

(57) ABSTRACT

Foams based on micro and nanofibrillated cellulose, subjected to the oxidation process, and combined with natural rubber latex are revealed, as well as their production process, which involves mixing, freezing and freeze-drying steps. Foams have high porosity, structural resilience in liquid media and high adsorption capacity for organic compounds (such as dyes and detergents) and inorganic heavy metal compounds, not showing ecotoxicity and can be applied to remediate environments contaminated by these compounds.

### CROSS REFERENCE

This application is a national stage entry application under 35 U.S.C. 371 of PCT Patent Application No. PCT/BR2022/050410, filed on Oct. 25, 2022, which claims priority to Brazilian patent application Ser. No. 1020210213299, filed on Oct. 25, 2021 and Brazilian patent application Ser. No. 1020220216037, filed on Oct. 25, 2022, the entire contents of each of which are incorporated herein by reference.

### TECHNICAL FIELD

The present description is from the field of preparing macromolecular substances to produce articles or porous materials.

### BACKGROUND

The scarcity of fresh water suitable for consumption has been intensifying in different regions of the planet as a result of irregular disposal of sewage and pollution due to spills/leaks of organic and inorganic chemicals (heavy metals, dyes, etc), whether as a result of accidents, natural disasters or bad labor/industrial practices. Such contamination also occurs in maritime waters and estuaries, harming fishing, leisure and other activities linked to the seas and coasts. In general, the vast majority of contaminants are always harmful to all living beings that make up a given ecosystem, whether human or not.

The growing concern about environmental problems related to the contamination of river waters with pollutants (heavy metals, dyes, pesticides, detergents, etc) has demanded attention from both the industry and society as a whole. This occurs because although heavy metals are natural components found in the Earth's crust, some of them (Cu, Hg, Cd, Pb, etc) can be toxic, even in low concentrations. Furthermore, some of them can be bioaccumulative for the human body, representing a threat to human health (causing diseases such as cancer), and to other living beings, in which quantities of these metals are discarded excessively and irresponsibly.

It is worth noting that many environments contaminated by pollutants are complex mixtures, which contain various metals and dyes, such as waste from the textile industry discarded in effluents. This complexity makes the treatment of these contaminated media a greater challenge to be overcome.

Among the various strategies that can be applied in order to reduce the amount of these pollutants, absorbent and/or adsorbent materials show promise, due to their easy applicability and high specific surface area, making them efficient in water remediation, even in low quantities. However, most commercial absorbents and/or adsorbents are non-biodegradable or minimally biodegradable. Therefore, the search for biodegradable materials obtained from renewable sources has attracted attention.

In this scenario, biomass has emerged as a source of obtaining biodegradable and renewable polymers, applicable in the development of new absorbent/adsorbent materials. Among these materials, nanocellulose stands out, due to its abundance and excellent reinforcing properties, in addition to being a renewable and biodegradable material. Additionally, nanocellulose can be isolated from sugarcane bagasse, which is one of the main by-products of the ethanol production process and consists mainly of cellulose.

Cellulose (C₆H₁₀O₅) n is the most abundant natural polymer in nature, renewable and biodegradable, formed from glucose with β(1,4) linkages between D-glucose units. The polymer chains interact via intra- and intermolecular interactions, forming hydrogen bonds through the hydroxyl groups present in the monomeric units.

Nanometer-scale structures extracted from cellulose arouse considerable interest due to their intrinsic properties (different morphological structures, hydrophilicity, possibility of functionalization and abundance), and this allows applications in different segments. Nanocellulose extracted from plant biomass can be classified into two different denominations, according to its structure and extraction route: crystalline nanocellulose (CNC), which is the crystalline region of the polymer, composed of shorter and more rigid chains; and nanofibrillated cellulose (CNF), which consists of the crystalline and amorphous region of the polymer with longer chains. Furthermore, these nanostructures can be used in their original form as polymer matrix in composites, since they have low density, high rigidity, surface modification capacity, and high aspect ratio.

The process of obtaining nanocellulose requires defibrillation of the cellulose, a method called “top-down”, in which the biomass bulk made up of fibers and microfibers are comminuted into fibrils with nanometric dimensions. This process can be carried out via chemical and/or mechanical methods, thus altering its final properties.

The most common chemical process for obtaining nanocellulose is acid hydrolysis, assisted with strong acids (sulfuric or hydrochloric). In this process, hydrolysis occurs in the amorphous regions of cellulose fibers, isolating cellulose nanocrystals (CNC). Mechanical processes require equipment that applies high shear energy to the cellulose suspension, such as ball mills, ultrasound and high-pressure microfluidizers. Such processes result in nanofibrillated cellulose (CNF) with average diameters depending on the number of cycles and the amount of applied energy.

Due to the abundant amount of hydroxyl groups on the surfaces of the cellulose chains that make up these nanostructures, it is possible to combine chemical cellulose functionalization processes, such as acetylation and graphitization or even TEMPO oxidation (N-oxyl-2,2,6,6-tetramethylpiperidine), which together with mechanical processes, favor fibrillation and obtaining functionalized CNF with uniform morphology and average diameter, and that when applied in the production of porous materials, this CNF can produce structures with high porosity, more homogeneous pore sizes and with micro and nanometric dimensions.

CNFs, which are one of the raw materials of this invention, show promise in the production of porous materials (aerogels, foams and sponges) due to their characteristics of renewability, biodegradability and support in three-dimensional porous structures with high specific surface area.

Known applications include acoustic and thermal insulation, membranes for water decontamination, biological growth scaffolds for bone regeneration or tissue printing, and electronic devices for energy generation and storage.

The viability of foams based on nanocellulose is also due, among other factors, to the simplicity of their method of obtaining, which includes mixing the components added to the nanocellulose suspension, subsequent freezing and sublimation (removal) of water through the freeze-drying process.

For effective adsorption of the pollutants, the porous material must remain structurally resilient for a considerable period of time in order to achieve maximum adsorption. However, due to its inherent hydrophilicity, resulting from the high availability of solvatable hydroxyl groups in aqueous media, the use of nanocellulose as a filtering foam or pollutant absorber in aqueous media is not viable. In this context, crosslinking agents are added to nanocellulose, interconnecting the nanostructure chains by physical or chemical means, in order to obtain a porous and structurally resilient 3D structure in aqueous media.

Natural rubber latex (NRL) extracted from rubber trees has unique properties, especially when compared to its synthetic analogue, polyisoprene. The distinguished characteristics of NRL come from its natural composition. The amount of polyisoprene in NRL can be estimated at 96% m/m, with 1% m/m protein and 3% m/m phospholipids. These almost 4% of different compounds in NRL give it unique properties, stabilizing the polyisoprene particles, surrounding this hydrophobic core with a protein-phospholipid layer that gives it a negative charge, this being the property responsible for the colloidal stability necessary for its effective homogeneous dispersion in polymeric matrices, such as nanofibrillated cellulose matrix.

In view of the above, there is a demand for the development of new structurally resilient porous materials in aqueous media based on biopolymers with high porosity and specific surface area, whose functionalization with groups that sequester inorganic and organic pollutants, such as heavy metals, dyes and detergents allows its application in the remediation of aquatic environments.

### PRIOR ART

Patent document US20190309144 describes an airgel or foam comprising CNF. Its production process is also described, which uses at least one organic solvent, as well as one or more degreasing agents. crosslinking. Such components are not environmentally friendly, which is a disadvantage of the technique described in this document.

Patent document EP3335695 discloses a hydrogel-like foam comprising TEMPO-oxidized CNF, trehalose and polyethylene glycol. This document also describes the production process of this foam, wherein one of the steps involves the freeze-drying process. The described formulation is not suitable for producing foams (which have a solid content below 10% by mass, preferably below 8% by mass), due to the increase in viscosity in the presence of trehalose and polyethylene glycol.

Patent document SE539714C2 describes a foam comprising fibrillated (CNF) or crystalline (CNC) nanocellulose, oxidized by periodate. The process of producing this foam, which involves cross-linking control through highly complex steps of ice growth followed by thawing, is also described. Such a process strongly depends on strict temperature control as a function of freezing time to achieve the described airgel.

Patent document FI127764B presents a method of treating water with CNF oxidized by TEMPO, wherein nanocellulose acts as a filtering agent for heavy metals in a network formed by CNF. Such nanocellulose is not processed to obtain the foam. The use of cellulose in this way brings some disadvantages, such as the difficulty in removing residual nanocellulose after treating the polluted aqueous environment and difficulty in separating nanocellulose and water, making it impossible to reuse the material.

Patent document U.S. Pat. No. 10,350,576 discloses a process for producing an airgel that comprises cellulose nanocrystals or nanofibrillates functionalized with organosilane groups through heating, being applied to the removal of hydrophobic pollutants. A limitation of the described object is evident in its difficulty in removing hydrophilic and amphiphilic pollutants due to the high hydrophobicity of the revealed airgel.

Patent document BR02020022041-1 anticipates a hydrophobic foam comprising natural rubber latex (NRL) and cellulose in fibrillar format, preferably micro and nanofibrillated cellulose. The components stabilize the polyisoprene particles of this latex, surrounding its hydrophobic core with a protein-phospholipid layer that gives it a negative charge, being responsible for the colloidal stability necessary for its effective dispersion in polymeric matrices, such as the nanofibrillated cellulose matrix, eliminating the need for the addition of any stabilizing, dispersing and crosslink for this purpose. A limitation of the aforementioned is the fact that the cellulose described in this document does not undergo refinement by oxidation, having less control over the size of the resulting mixture of microstructures and nanostructures. As a result of the lack of refinement in the control of diameters in cellulose, the resulting foam mostly presents micrometer-sized pores and high hydrophobicity, making it difficult to capture pollutants such as hydrophilic dyes and amphiphilic materials.

### SUMMARY OF THE INVENTION

It is an objective of the present description to reveal a foam based on materials from a natural and renewable source, with high porosity, low density and high adsorption capacity for inorganic (heavy metals precursors) and organic (dyes and detergents) compounds, which can be applied as an absorbent material in the remediation of river systems or as a protection against their contamination. It is also the objective of the present description to disclose a production process for said foam.

The objects of the present invention are achieved by a foam comprising oxidized nanofibrillated cellulose and natural rubber latex. The objectives of the present invention are also achieved by a foam production process based on oxidized fibrillated cellulose and natural rubber latex, wherein the process comprises:

adding cellulose in micro and nanofibrillar format, previously oxidized and homogenized to a dispersion of natural rubber latex;
stirring the mixture mechanically to homogenize;
filling molds with the mixture;
freezing the mixture in the mold at −10° C. for a period between 18 and 30 h;
freeze-drying the mixture at 10 mBar and a temperature of −45° C., for a period between 24 and 48 h.

### BRIEF DESCRIPTION OF THE DRAWINGS

The present invention is illustrated in the embodiments represented in figures, as briefly described below.

FIGS. 1a to 1h are a series of images of an embodiment of the foams of the present description subjected to a commercial detergent retention test, in which: FIGS. 1a and 1b are photographs of the foam dry and submerged in detergent, respectively; FIGS. 1c, 1e and 1g are X-ray microtomographic images of the dried foams; and, FIGS. 1d, 1f and 1h are X-ray microtomographic images of the foams after being submerged in detergent.

FIGS. 2a and 2b are two photographs of hydrophobic foams, according to a prior art embodiment, subjected to a detergent retention test, at the beginning and end of the test, respectively.

FIG. 3a is a photograph of hydrophilic foams, according to an embodiment of the present description, subjected to structural resilience testing in an aqueous medium for 24 hours.

FIGS. 3b and 3c are two photographs of hydrophilic foams, according to an embodiment of the present description, subjected to a detergent retention test, at the beginning of the test and after 24 hours of testing, respectively.

FIGS. 4a to 4c are representative photographs of the steps of an adsorption test and evaluation of the porous microstructure of one embodiment of the hydrophilic foams of the present description subjected to immersion in a copper chloride solution for 24 hours.

FIG. 4d is a microtomography image of one embodiment of the foams of the present description after adsorption of copper ions.

FIGS. 4e and 4f are photographic and microtomographic images, respectively, of an embodiment of the foam of the present description before adsorption of copper ions.

FIG. 5 illustrates the ecotoxicity test of the hydrophilic foams of the present description. FIG. 5a summarizes the first step of the ecotoxicity test, which involves the process of obtaining the lethal concentration that kills 50% of living organisms (LC₅₀) for Daphnia similis when exposed to Cu (II) ion solutions. FIG. 5b shows the remediation process of media containing Cu (II) ions using hydrophilic foams pretreated or not with humic acid (HA). FIG. 5c shows the D. similis organisms exposure protocol to systems remedied with hydrophilic foams. FIG. 5d illustrates the response property used in the ecotoxicity assay: living (ecologically benign) and dead (toxic) organisms.

### DETAILED DESCRIPTION OF THE INVENTION

The present description discloses a foam comprising natural rubber latex (NRL) and cellulose in fibrillar format, specifically oxidized micro and nanofibrillated cellulose. The aforementioned oxidized micro and nanofibrillated cellulose foams are produced using “green” routes (using renewable components and eliminating the use of solvents, that is, using only water as a solvent). This production process involves the incorporation of natural rubber latex (a biopolymer commonly extracted from Hevea brasilienses) as a crosslinking agent for cellulose nanofibrils in aqueous media.

The oxidized micro and nanofibrillated cellulose described herein undergoes refinement by oxidation, having greater control over the size of the resulting microstructures and nanostructures. As a result of greater control over the diameters of cellulose nanofibers, the foams obtained had a low solids content (below 8% by mass, preferably below 2%), high porosity (porosity above 80%, with nanometric-sized pores) and high mechanical-structural stability in aqueous media, compared to prior art foams formed by NRL and non-oxidized fibrillar cellulose, facilitating the capture of pollutants such as hydrophilic dyes and amphiphilic materials.

The presence of the cellulose's negative charge, due to the previous oxidation process, makes it possible to capture pollutants charged with opposite charges, such as cationic dyes and heavy metal ions, expanding the range of applications of these foams.

In one embodiment of the present description, the foams comprise cellulose with oxidized fibrillar morphology with micro and nanometric dimensions.

In one embodiment of the present description, the foams comprise cellulose with oxidized fibrillar morphology containing carboxylic groups.

In one embodiment of the present description, the foams comprise cellulose with oxidized fibrillar morphology from at least one natural source selected from the group comprising eucalyptus, sugar cane bagasse and mixtures thereof.

In one embodiment of the present description, the foams comprise a concentration of natural rubber latex in dry mass between 5 and 50%.

In one embodiment of the present description, the foams comprise natural rubber latex with a pH between 7 and 9.

In one embodiment of the present description, the foams comprise natural rubber latex from Hevea brasilienses.

In one embodiment of the present description, the foam production process comprises:
adding cellulose with nanofibrillated morphology, previously oxidized and homogenized to a dispersion of natural rubber latex;
stirring the mixture mechanically to homogenize;
filling molds with the mixture;
freezing the mixture in the mold at −10° C. for a period between 18 and 30 hours;
freeze-drying the mixture at 10 mBar and a temperature of −45° C., for a period between 24 and 48 hours.

In one embodiment of the present description, at least one of the mold walls has lower thermal conductivity than the other mold walls.

The various types of foams described here, due to their characteristics and production processes, find a wide range of applications, including: use for adsorption of dyes; use for adsorption of detergents; use for adsorption of inorganic precursor salts of heavy metals, such as Cu, Cd, Pb, Hg and Ag.

In one embodiment of the present description, said foams are used for decontamination and remediation of waters, such as waters disposed in reservoirs or found in the environment.

In one embodiment of the present description, said foams are used for decontamination and remediation of waters, and the media decontaminated/remediated with them do not exhibit ecotoxicity.

### EXAMPLES OF EMBODIMENT OF THE INVENTION

In the following paragraphs, non-limiting examples of embodiments of the present invention are presented that have the same inventive concept as the previously described embodiments.

### Example 1: Holding Capacity of Commercial Detergent

In this example, the detergent retention capacity of the foams of the present invention was evaluated, considering a composition containing natural rubber latex (NRL) and oxidized nanofibrillated cellulose (CNF), whose source was sugar cane bagasse. The foam was produced according to the method described below.

For the composition, it was used an aqueous dispersion of NRL extracted from the species Hevea brasilienses with an ammonia percentage of 0.9% and 62.5% total solids content, and CNF with 2% m/m solids content containing cellulose nanofibrils from sugarcane bagasse.

In this exemplary embodiment, the foams were obtained in a process involving two steps. The first involves the functionalization of CNF from sugarcane bagasse, and the second involves the homogenization of oxidized CNF with NRL in proportions of 80% CNF and 20% latex, all in dry mass.

Oxidized CNF was obtained through the oxidation of bleached pulp mediated by TEMPO (N-oxyl-2,2,6,6-tetramethylpiperidine). Thus, 13 g of bleached pulp were immersed in 1300 ml of distilled water for 24 hours. Then, the system was shaken to homogenize the suspension. A PH meter is coupled to the system and 1.3 g of NaBr and 0.208 g of TEMPO were added. The addition of 40 g of NaClO (12%) was done slowly in order to keep the pH constant and equal to 10. This was done with the addition of a NaOH solution (0.5M). The entire procedure was performed between 100 and 130 min. Once the reaction was complete, HCl was added to neutralize the suspension (pH 7). The oxidized CNF was washed to remove excess reagent.

The mixture of homogenized oxidized CNF (previously sonicated in tip ultrasound with an amplitude of 40% for 5 min under an ice bath) and the dispersion of NRL was made with a final solids content equal to 2% m/m. The mixture was subjected to mechanical stirring for 30 min at a temperature of 27° C. This amount of solids resulted in a suitable viscosity for filling cylindrical polyethylene molds. The molds were filled with the CNF/NRL mixture and placed in a freezer for 24 hours at −10° C. They were subsequently subjected to the freeze-drying process for 48 hours to completely sublimate the ice contained in the samples.

The foams were immersed in 10 mL of yellow commercial detergent (Limpol™ brand, produced by the company Bombril S.A., Brazil) for a detergent retention time of 5 minutes. Measurements were acquired in quintuplicate after 5 minutes in equilibrium with the commercial detergent, as shown in Table 1.

TABLE 1
Retention capacity (Q) of commercial detergent after five minutes
of immersion.

| Foam composition | | | |
|---|---|---|---|
| CNF/NRL | M₀ (mg) | M_{f} (g) | Q (g/g) |
| 80/20 | 63.6 | 2.49 | 38.2 |
| 80/20 | 53.0 | 2.14 | 39.3 |
| 80/20 | 59.3 | 2.48 | 40.7 |
| 80/20 | 76.3 | 3.24 | 41.5 |
| 80/20 | 65.4 | 2.58 | 38.5 |

The absorption or retention capacity (Q) was calculated from equation (1):

$$Q = ( {M}_{f} - {M}_{0} ) / {M}_{0} \qquad ( Equation 1 )$$

Wherein Mf e Mo are, respectively, the masses of the foams after absorption and drying. The detergent retention capacity was (39.7±1.4) g/g, when compared to the dry foam mass itself (before detergent retention).

### Example 2: Reuse of Foams to Retain Detergents

In this example, the same foams as in Example 1 were subjected to consecutive reuse tests. The tests are described below.

Initially, the foams from Example 1 were submerged in water for 20 hours, to clean and remove the retained detergent. After this immersion time, the foams were removed from the water and dried at room temperature for 48 h. Then, each foam was immersed in 10 mL of yellow commercial detergent (Limpol™) for a detergent retention time of 5 minutes. Measurements were acquired in quintuplicate for the foams. The retention capacity (Q) of the detergent by the foams is described in Table 2. The Q value of the Limpol™ detergent was (23.5±4.9) g/g, when compared to the mass of the dry foam itself (before detergent retention). The reuse of foams showed a detergent retention efficiency of 60%.

TABLE 2
Retention capacity (Q) of commercial detergent (Limpol ™) in five
minutes of immersion for the first reuse cycle.

| Foam composition | | | |
|---|---|---|---|
| CNF/NRL | M₀ (mg) | M_{f} (g) | Q (g/g) |
| 80/20 | 67.4 | 1.82 | 26.1 |
| 80/20 | 53.4 | 1.03 | 18.2 |
| 80/20 | 79.5 | 2.49 | 30.4 |
| 80/20 | 68.3 | 1.39 | 19.3 |
| 80/20 | 64.8 | 1.58 | 23.4 |

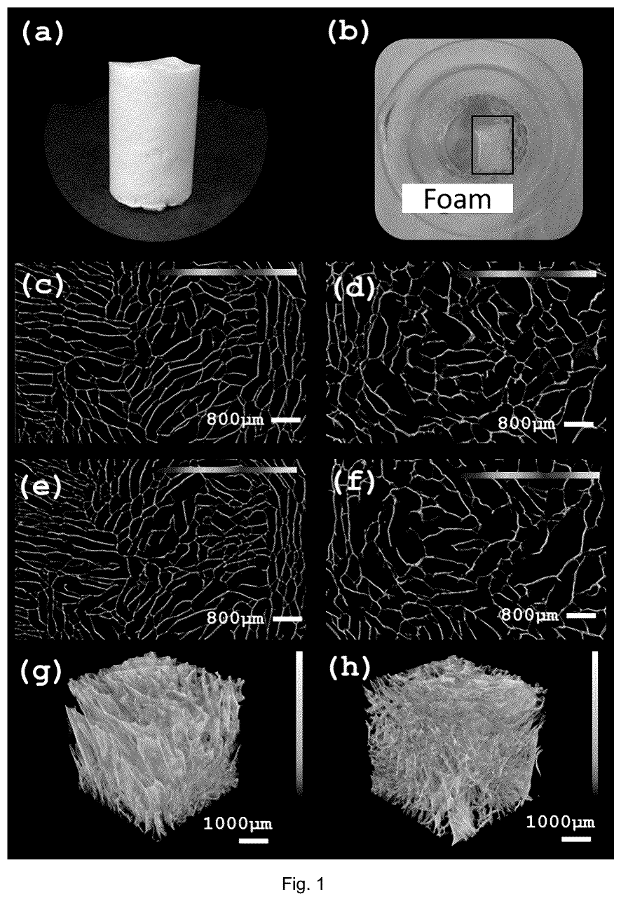

The CNF80/NRL20 foams from the first reuse cycle were dried and analyzed for their internal porous microstructure by X-ray microtomography, in order to evaluate the possible structural changes caused by the retention/reuse process. FIGS. 1a to 1f present the data obtained for foams before and after the reuse test, illustrating, respectively, the shape of the foams and their submission to the detergent retention test. It can be seen that in the test all the foam is submerged in the detergent, thus indicating the high filling capacity, as well as affinity to the detergent. Furthermore, air bubbles are eliminated, showing the retention of the detergent inside the foam.

The porous microstructure of the foams was verified by 2D projections, as shown in FIGS. 1c to 1f. Comparing the internal microstructures of the dry foam (FIGS. 1c and 1e), with the foam subjected to the reuse process (FIGS. 1d and 1f), it was found that the addition of NRL allowed the maintenance of the pores, keeping the morphology practically unchanged. Porosity, an important factor for absorbent materials, remained practically constant after reuse cycles, approximately 90% (before and after reuse). It is worth noting that, given the hydrophilicity of cellulose, this maintenance of the 3D structure after reuse is a differentiator. And this can be correlated to the high degree of entanglement of the oxidized fibrillated cellulose and effective crosslinking resulting from the addition of NRL without the need to use organic solvents or additional curing steps, characterizing an important difference compared to other prior art technologies.

After the first reuse test, the same foams were subjected to the second and third reuse test. The test is described as follows: foams were submerged in water for 20 h, to clean and remove retained detergent. After this immersion time, they were removed from the water and dried at room temperature for 2 days. Then, each foam was immersed in 10 mL of yellow commercial detergent (Limpol™) for a detergent retention time of 5 minutes. Measurements were acquired in quintuplicate for the foams. The detergent retention capacity (Q) of the foams was calculated according to Equation 1 and the calculated values are organized in Table 3 and Table 4, referring, respectively, to the second and third reuse test.

TABLE 3
Retention capacity (Q) of commercial detergent (Limpol ™) in five
minutes of immersion in the second reuse test.

| Foam composition | | | |
|---|---|---|---|
| CNF/NRL | M₀ (mg) | M_{f} (g) | Q (g/g) |
| 80/20 | 59.4 | 0.9418 | 14.86 |
| 80/20 | 64.8 | 1.8602 | 27.71 |
| 80/20 | 63.7 | 1.1323 | 16.78 |
| 80/20 | 63.0 | 1.5082 | 22.94 |
| 80/20 | 52.0 | 1.1997 | 22.97 |

The Q value of Limpol™ detergent was (21.1±5.2) g/g for the second test, when compared to the dry foam mass itself (before detergent retention).

TABLE 4
Retention capacity (Q) of commercial detergent (Limpol ™) after five
minutes of immersion in the third reuse test.

| Foam composition | | | |
|---|---|---|---|
| CNF/NRL | M₀ (mg) | M_{f} (g) | Q (g/g) |
| 80/20 | 75.4 | 1.9990 | 26.4 |
| 80/20 | 63.1 | 0.7895 | 11.5 |
| 80/20 | 62.2 | 1.5809 | 24.4 |
| 80/20 | 64.0 | 1.6507 | 24.8 |
| 80/20 | 57.9 | 0.7903 | 12.6 |

In the case of the third test, the Q value was (20±7) g/g. The reuse of the foams showed a detergent retention efficiency of between 86 and 90%, in relation to the reuse cycles (cycles 1, 2, and 3). This demonstrates the effectiveness of use in repeated retention cycles, maintaining its 3D structural architecture, and the eco-sustainable characteristic of this material.

### Example 3: Preparation of Foams with Non-Oxidized Cellulose for Commercial Detergent Retention Capacity

In this example, a detergent retention test was carried out with state-of-the-art foams (according to previous document BR02020022041-1) formed from non-oxidized CNF combined with NRL, for comparison with foams obtained with oxidized CNF, as per the present description.

Non-oxidized CNF foams were obtained in a process that involves the homogenization of non-oxidized CNF with NRL in proportions of 80% CNF and 20% latex, all in dry mass.

The mixture of homogenized non-oxidized CNF (previously sonicated in tip ultrasound with an amplitude of 40% for 5 min under an ice bath) and the dispersion of NRL was made with a final solids content equal to 2% m/m. The mixture was subjected to mechanical stirring for 30 min at a temperature of 27° C. This amount of solids resulted in a suitable viscosity for filling cylindrical polyethylene molds. The molds were filled with the CNF/NRL mixture and placed in a freezer for 24 hours at −10° C. They were subsequently subjected to the freeze-drying process for 48 hours to completely sublimate the ice contained in the samples.

The foams were then immersed in 10 mL of yellow commercial detergent (Limpol™) for a detergent retention time of 5 minutes. Measurements were acquired in quintuplicate after 5 minutes in equilibrium with the commercial detergent, as shown in Table 5.

TABLE 5
Retention capacity (Q) of commercial detergent (Limpol ™) after five
minutes of immersion.

| Foam composition | | | |
|---|---|---|---|
| CNF/NRL | M₀ (mg) | M_{f} (g) | Q (g/g) |
| 80/20 | 65.5 | 1.7038 | 25.0 |
| 80/20 | 61.8 | 1.6548 | 25.8 |
| 80/20 | 62.0 | 1.6393 | 25.4 |
| 80/20 | 49.7 | 1.4407 | 27.9 |
| 80/20 | 61.1 | 1.6583 | 26.2 |

The detergent retention capacity (Q) for foams with non-oxidized CNF was (26.1±1.2) g/g, below those produced with oxidized CNF (39.7±1.4) g/g. The increase in Q value may be related to the oxidation of CNFs. The existence of these functional groups promotes greater entanglement of nanofibrils, resulting in a hydrated three-dimensional structure, which when subjected to the freezing process and subsequent freeze-drying results in architectures with greater porosity, smaller pores and greater specific surface area. This greater surface area can be closely correlated with the significant increase in the Q value, thus justifying the need for oxidation of CNFs to gain absorption of amphiphilic components.

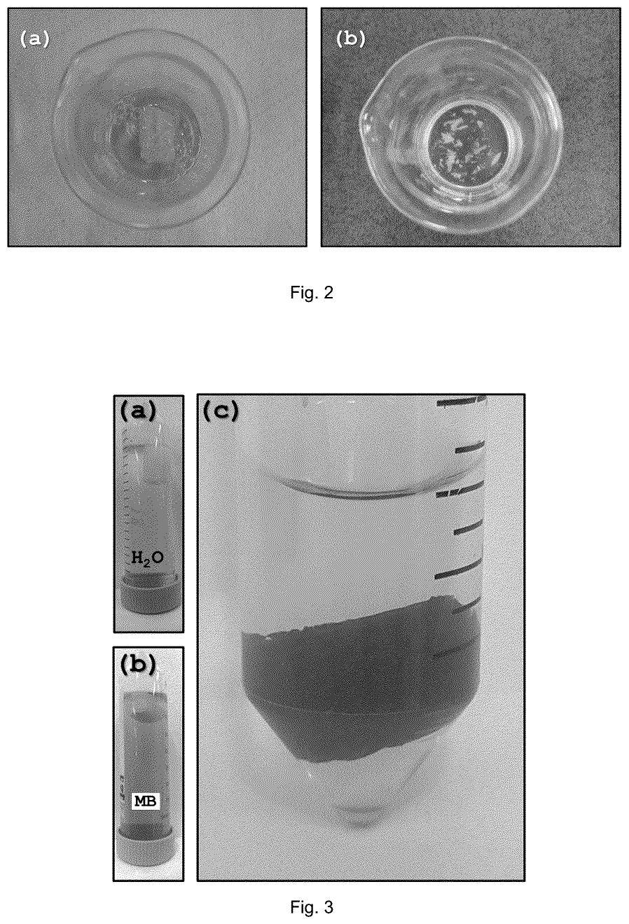

In parallel with the increase in the Q value, the lack of oxidation of CNF impedes the structural resilience of the foam in a liquid medium. FIGS. 2a and 2b illustrate the foam subjected to the retention test. In FIG. 2a, the foam is inserted into the liquid and remains apparently intact. However, after the retention time of 5 min has elapsed, it is possible to see the appearance of fragments and/or materials (FIG. 2b) in which such fragments are detached from the foam. This behavior was not observed for oxidized CNF foams. The 3D architecture remained intact even after reuse cycles, as evidenced in the 3D X-ray microtomography images in FIGS. 1g to 1h.

### Example 4: Preparation of Foams for Cationic Dye Retention (Methylene Blue, AM)

In this exemplary embodiment, the foams were obtained in a process involving two steps. The first involves the functionalization of CNF from sugarcane bagasse, and the second involves the homogenization of oxidized CNF with NRL in proportions of 80% CNF and 20% latex, all in dry mass.

Oxidized CNF was obtained through the oxidation of bleached pulp mediated by TEMPO (N-oxyl-2,2,6,6-tetramethylpiperidine). Thus, 13 g of bleached pulp were immersed in 1300 ml of distilled water for 24 hours. Then, the system was shaken to homogenize the dispersion. A PH meter is coupled to the system and 1.3 g of NaBr and 0.208 g of TEMPO were added. The addition of 40 g of NaClO (12%) was done slowly in order to keep the pH constant and equal to 10. This was done with the addition of a 0.5 M NaOH solution. The entire procedure was carried out between 100 and 130 min. Once the reaction was complete, HCl was added to neutralize the suspension, resulting in pH 7. The oxidized CNF was washed to remove excess reagent.

The mixture of homogenized oxidized CNF (previously sonicated in tip ultrasound with an amplitude of 40% for 5 min under an ice bath) and the dispersion of NRL was made with a final solids content equal to 2% m/m. The mixture was subjected to mechanical stirring for 30 min at a temperature of 27° C. This amount of solids resulted in a suitable viscosity for filling cylindrical polyethylene molds. The molds were filled with the CNF/NRL mixture and placed in a freezer for 24 hours at −10° C. They were subsequently subjected to the freeze-drying process for 48 hours to completely sublimate the ice contained in the samples.

The foams show good structural resistance when immersed for 24 hours in water, as shown in FIG. 3a, thus indicating the possibility of evaluating the adsorption of the methylene blue (MB) dye. FIGS. 3b and 3c illustrate the dye adsorption test by the foams. These were immersed in MB solution in 50 mL Falcon tubes, illustrated in FIG. 3c. The methylene blue (MB) isothermal adsorption test was carried out by immersing known foam masses in different concentrations of the dye over an interval of 24 hours and at a temperature of 27° C. The mass of the CNF/NRL foams was cataloged and identified as (mᵢₙᵢₜᵢₐₗ). The values are organized in Table 6. Different concentrations of MB (from 0.1 to 1000 mg/L) were prepared. Such concentrations were called “Cᵢₙᵢₜᵢₐₗ”. The previously weighed foams were immersed in 25 mL of each concentration. After 24 hours, a 2 mL aliquot was removed from each container and the concentration reached equilibrium (C_{eq}) was measured by UV-vis spectroscopy at 664 nm. A calibration curve (0.1-10 mg/L) was made with R²=0.997 for correlation of absorbance at 664 nm and corresponding concentration. With the values of C_{eq}, Cᵢₙᵢₜᵢₐₗ, the volume of the solution (Vₛₒₗᵤₜᵢₒₙ=25 ml), the mass of the foam (mᵢₙᵢₜᵢₐₗ), and from Equation 1, the amount of MB adsorbed (Q_{MB}) in mg/g of foam. All measurements were made in duplicate.

TABLE 6
Initial mass of the foams, initial concentration, at equilibrium, adsorbed
amount of Methylene Blue (Q_{MB}).

| Foam dough | Immersion time | Cᵢₙᵢₜᵢₐₗ | C_{eq} | Q_{MB} |
|---|---|---|---|---|
| (mg) | (h) | (mg/L) | (mg/L) | (mg/g) |
| 63 ± 3 | 24 | 100 | 11 ± 06 | 35 ± 4 |
| 56 ± 2 | | 200 | 43 ± 06 | 70 ± 6 |
| 60 ± 3 | | 300 | 43 ± 10 | 107 ± 8 |
| 58 ± 1 | | 400 | 121 ± 44 | 114 ± 10 |
| 58 ± 9 | | 500 | 130 ± 39 | 171 ± 32 |
| 56 ± 2 | | 600 | 299 ± 12 | 145 ± 8 |
| 54 ± 7 | | 700 | 352 ± 30 | 151 ± 15 |
| 59 ± 3 | | 800 | 409 ± 13 | 158 ± 7 |
| 59 ± 4 | | 1000 | 566 ± 62 | 220 ± 70 |

The foams demonstrated high MB adsorption, with the Q_{MB} value being close to 250 mg/g adsorbed after 24 hours. This can be visually verified by the change in color of the solution and foam (FIG. 3c), visually showing dye retention. Even with low dye availability (concentrations close to 100 ppm or 100 mg/L), the foam proved to be effective, reducing the initial concentration by almost 90%. In terms of oxidation effectiveness and the source of obtaining cellulose in methylene blue adsorption capacity, foams based on non-oxidized CNF from Eucalyptus and NRL demonstrated MB absorption capacity of around 105±8 mg/g when immersed in MB solutions (between 50 and 800 mg/g), indicating that the foam analyzed here (oxidized CNF and NRL) has properties superior to those already existing in the prior art and that cellulose oxidation is essential for this adsorption performance, with the addition of the plurality of sequestration of metals, dyes, and detergents, something still unprecedented.

### Example 5: Preparation of Foams for Copper Ion Retention

In this present invention, the foams were obtained in a process involving two steps. The first involves the functionalization of CNF from sugarcane bagasse, and the second involves the homogenization of oxidized CNF with NRL in proportions of 80% CNF and 20% latex, all in dry mass.

Oxidized CNF was obtained through the oxidation of bleached pulp mediated by TEMPO (N-oxyl-2,2,6,6-tetramethylpiperidine). Thus, 13 g of bleached pulp were immersed in 1300 ml of distilled water for 24 hours. Then, the system was shaken to homogenize the suspension. A PH meter is coupled to the system and 1.3 g of NaBr and 0.208 g of TEMPO were added. The addition of 40 g of NaClO (12%) was done slowly in order to keep the pH constant and equal to 10. This was done with the addition of a NaOH solution (0.5M). The entire procedure was performed between 100 and 130 min. Once the reaction was complete, HCl was added to neutralize the suspension, resulting in pH 7. The oxidized CNF was washed to remove excess reagent.

The mixture of homogenized oxidized CNF (previously sonicated in tip ultrasound with an amplitude of 40% for 5 min under an ice bath) and the dispersion of NRL was made with a final solids content equal to 2% m/m. The mixture was subjected to mechanical stirring for 30 min at a temperature of 27° C. This amount of solids resulted in a suitable viscosity for filling cylindrical polyethylene molds. The molds were filled with the CNF/NRL mixture and placed in a freezer for 24 hours at −10° C. They were subsequently subjected to the freeze-drying process (10 mBar) for 48 hours to completely sublimate the ice contained in the samples.

The adsorption capacity of Copper II ions was evaluated based on the isothermal adsorption test of known masses of foams inserted in copper chloride solutions. For this, different copper chloride solutions ranging between 15 and 700 mg/L were prepared and equilibrated at 27° C. Such concentrations were called “Cᵢₙᵢₜᵢₐₗ”. The mass of the CNF/NRL foams was cataloged and identified as “mᵢₙᵢₜᵢₐₗ”. The mᵢₙᵢₜᵢₐₗ values and Cᵢₙᵢₜᵢₐₗ obtained from this example are quantified in Table 7.

TABLE 7
Copper (II) adsorption capacity. Initial mass of the foams, initial
concentration at equilibrium and adsorbed amount of Copper Il ions.

| Foam mass mᵢₙᵢₜᵢₐₗ | Cᵢₙᵢₜᵢₐₗ | C_{eq} | Q_{II} |
|---|---|---|---|
| (mg) | (mg/L) | (mg/L) | (mg/g) |
| 61.0 ± 7.1 | 25.44 | 16.1 ± 0.5 | 39 ± 6 |
| 56.4 ± 4.1 | 37.37 | 23.9 ± 2.5 | 59 ± 10 |
| 64.4 ± 1.1 | 65.71 | 39.7 ± 0.8 | 101 ± 4 |
| 57.9 ± 4.4 | 96.43 | 66.1 ± 4.3 | 131 ± 15 |
| 62.7 ± 3.9 | 205.42 | 152.6 ± 6.6 | 210 ± 17 |
| 62.1 ± 3.3 | 351.55 | 264.9 ± 4.7 | 349 ± 31 |
| 66.0 ± 9.3 | 564.66 | 387.5 ± 9.4 | 325 ± 36 |
| 57.3 ± 2.6 | 687.02 | 508.3 ± 2.4 | 246 ± 22 |

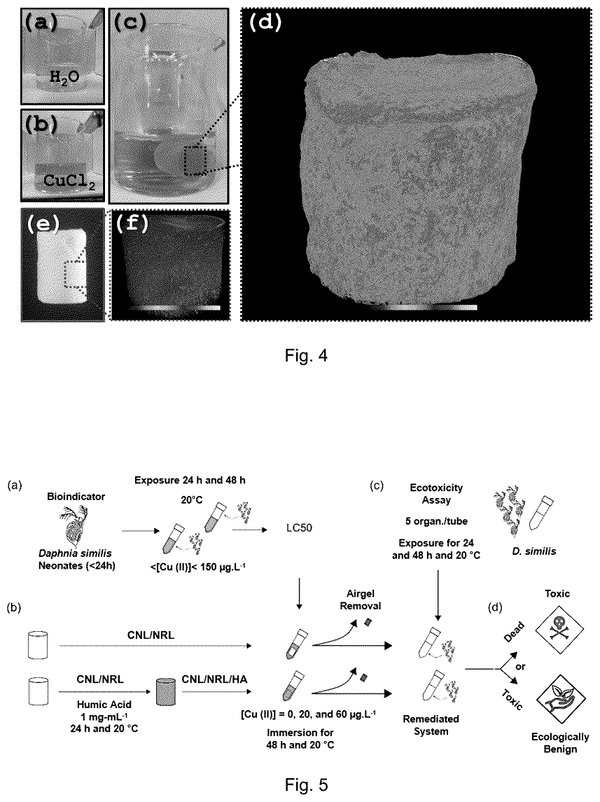

The previously weighed foams were immersed in 25 mL of each concentration, as illustrated in FIGS. 4a to 4c. After 24 hours, a 2 mL aliquot was removed from each container. This concentration was called the equilibrium concentration “C_{eq}”. This concentration was measured via plasma optical emission spectrometry (ICP-OES). A calibration curve (20-200 mg/L) was made with R²=0.997 for correlation of the plasma signal and the Copper II ion concentration of the sample. With the values of C_{eq}, Cᵢₙᵢₜᵢₐₗ, the volume of the solution (Vₛₒₗᵤₜᵢₒₙ=25 mL), foam mass (mᵢₙᵢₜᵢₐₗ), and using equation 1, the amount of adsorbed Copper II (Qui) in mg per gram (mg/g) of foam. All measurements were done in triplicates.

From the data presented in Table 7, it appears that oxidized CNF and NRL foams are effective in sequestering copper ions. The amount adsorbed here reached values of around 350 mg of Cu II adsorbed per gram of foam. The adsorption capacity for different concentrations was verified. Even at very low values (˜25 ppm) the foams were effective in sequestering more than 40% of the ions available in solution. In short, for all of these, the sequestration was effective and with values above those reported in the literature (between 20 and 100 mg/g).

Additionally, the adsorption of Cu II ions on the foam was analyzed by X-ray microtomography, in order to identify possible morphological changes, as well as differences in X-ray attenuation, after the adsorption of copper ions. This test was carried out with the samples after immersion in a CuCl₂ solution and subsequently dried for 2 days (FIG. 4d), as well as in the dry foams (FIGS. 4e and 4f) before immersion. The reconstruction of the images of the foams before and after the adsorption test clearly shows regions with greater X-ray attenuation (regions in blue-FIG. 4d), which indicates the retention of specimens with greater electron density, allowing us to infer that this is the adsorption of copper II by the foam. This becomes more evident when we compare this reconstruction with the one made for the foam before the test (FIG. 4g). In this last figure, it is possible to see only the signal attenuated to lower values, commonly correlated to materials composed of carbon, such as nanofibrillated cellulose. These data confirm the effectiveness of the foam containing CNF/NRL in maintaining its porous structure when subjected to aqueous environments and high adsorption capacity for heavy metals, as verified for copper II. Such confirmations are closely correlated with the addition of NRL and cellulose oxidation, respectively.

### Example 6: Preparation of Foams for Remediation and Ecotoxicity Testing

The foams were obtained in a process that involves two steps. The first involves the functionalization of CNF from sugarcane bagasse, and the second involves the homogenization of oxidized CNF with NRL in proportions of 80% CNF and 20% latex, all in dry mass.

Oxidized CNF was obtained through the oxidation of bleached pulp mediated by TEMPO (N-oxyl-2,2,6,6-tetramethylpiperidine). Thus, 13 g of bleached pulp were immersed in 1300 ml of distilled water for 24 hours. Then, the system was shaken to homogenize the suspension. A PH meter is coupled to the system and 1.3 g of NaBr and 0.208 g of TEMPO were added. The addition of 40 g of NaClO (12%) was done slowly in order to keep the pH constant and equal to 10. This was done with the addition of a NaOH solution (0.5M). The entire procedure was performed between 100 and 130 min. Once the reaction was complete, HCl was added to neutralize the suspension, resulting in a neutral pH (˜7). The oxidized CNF was washed with distilled water to remove excess reagent.

The mixture of homogenized oxidized CNF (previously sonicated in tip ultrasound with an amplitude of 40% for 5 min under an ice bath) and the dispersion of NRL was made with a final solids content equal to 2% m/m. The mixture was subjected to mechanical stirring for 30 min at a temperature of 27° C. This amount of solids resulted in a suitable viscosity for filling cylindrical polyethylene molds. The molds were filled with the CNF/NRL mixture and placed in a freezer for 24 hours at −10° C. They were subsequently subjected to the freeze-drying process (10 mBar) for 48 hours to completely sublimate the ice contained in the samples.

The proposed ecotoxicity test consisted of evaluating the ecotoxicity of the material and the exposure of a bioindicator to systems contaminated with Cu (II) that were previously remediated by these foams based on CNF and NRL. The bioindicator model used was from Daphia similis, in which the acute toxicity results (median mortality concentration—LC50—with 95% confidence interval (CI), estimated by the PriProbit software) were used as a response variable. Furthermore, in order to simulate an experiment closer to the real scenario, the presence of organic compounds, such as humic acid (HA-found in aquatic environments in concentrations between 1-20 mg L⁻¹) were incorporated in this assay, as they may interfere with the capture efficiency of Cu (II) ions. The ecotoxicity of CNF/NRL foam was evaluated.

Like this, the test was divided into three subsequent stages, which are schematized in FIG. 5. The first consisted of determining the LC50 value for D. similis. To this end, neonatal organisms of D. similis (<24 h) were exposed to media containing Cu (II) ions for 24 and 48 h under controlled temperature and photoperiod in biological incubators (B.O.D., Eletrolab EL212, SP, Brazil) (FIG. 5a). Cu (II) toxicity was evaluated at concentrations between 0 and 150 μg L⁻¹, values estimated based on those already reported in the literature for contaminated environments (0.03 to 30 μg L⁻¹).

The second included the remediation process of media containing Cu (II) ions in concentrations 0, 20, and 60 μg L⁻¹ for 48 h at 20° C., respectively above and below the pre-determined LC50 value. The lethal concentration values that kill 50% of the organisms (LC50) obtained were 33.0 and 28.36 μg L⁻¹ respectively for 24 and 48 h of exposure to Cu (II) ions.

Two groups of foams were investigated (FIG. 5b): CNF/NRL and CNF/NRL previously treated with humic acid (HA) (1 mg mL⁻¹ for 24 h at 20° C.), called CNF/NRL/HA. After 24 or 48 h, the foams were removed (FIG. 5b) and the remediated systems were used for the next step. In this third and final stage, the organisms D. similis were exposed to the remediated solutions (2 mL for each replicate) for 24 h and 48 h (FIG. 5c-d). Three experimental replicates and five biological replicates were considered for all experiments performed. The toxicity test results are organized in Table 1.

All organisms died after exposure to Cu (II) solutions at both 20 and 60 μg L⁻¹. However, for the systems treated with CNF/NRL and CNF/NRL/HA foams, no organism deaths were identified, thus indicating that these CNF/NRL foams completely reduced the toxicity of Cu (II) at doses greater than 60 μg. L⁻¹. The similarity of the results for the media treated with CNF/NRL and CNF/NRL/HA indicated that the presence of humic acid does not interfere with the CNF/NRL remediation process, even for high concentrations of HA. It can also be observed that the foams studied here did not interfere with the mortality rate, that is, 0% of dead organisms when exposed only to aerogels, demonstrating that such materials do not present risks to the lives of aquatic organisms.

TABLE 1
Number of organisms D. similis alive when exposed to systems
containing Cu (II) ions and remediated by CNF/NRL and
CNF/NRL/HA foams for 24 and 48 h.
Foam (CNF/NRL/HA) 24 h/48 h

| | | CNF/NRL | CNF/NRL | | |
|---|---|---|---|---|---|
| | | 20 μgL⁻¹ | 60 μgL⁻¹ | 20 μgL⁻¹ | 60 μgL⁻¹ |
| Quite | CNF/NRL | With (II) | With (II) | With (II) | With (II) |
| 5/5 | 5/5 | 5/5 | 5/5 | 0/0 | 0/0 |
| 5/5 | 5/5 | 5/5 | 5/5 | 0/0 | 0/0 |
| 5/5 | 5/5 | 5/5 | 5/5 | 0/0 | 0/0 |

Foam (CNF/NRL/HA) 24 h/48 h

| | | CNF/NRL/HA | CNF/NRL/HA | | |
|---|---|---|---|---|---|
| | CNF/NRL/ | 20 μg · L⁻¹ | 60 μg · L⁻¹ | −20 μgL⁻¹ | 60 μgL⁻¹ |
| Quite | HA | With (II) | With (II) | With (II) | With (II) |
| 5/5 | 5/5 | 5/5 | 5/5 | 0/0 | 0/0 |
| 5/5 | 5/5 | 5/5 | 5/5 | 0/0 | 0/0 |
| 5/5 | 5/5 | 5/5 | 5/5 | 0/0 | 0/0 |

CNF - cellulose nanofibrils; NRL - Natural Rubber Latex; HA - humic acid; the 5/5 nomenclature indicates living organisms and thus a non-toxic material.

Although exemplary embodiments of the processes and products described have been presented in this report, the scope of protection is not intended to be limited to their literal meaning. Therefore, the description should be interpreted not as limiting, but merely as exemplifications of particular embodiments of the inventive concept presented here. One skilled in the art can readily apply the teachings of this description in analogous solutions therefrom, limited only by the scope of the following claims.

1. Foam based on cellulose and natural rubber latex comprising:
oxidized cellulose with fibrillar morphology; and
natural rubber latex.

2. The foam, according to claim 1, wherein the oxidized cellulose with fibrillar morphology comprises micro and nanometric dimensions.

3. The foam, according to claim 1, wherein the oxidized cellulose with fibrillar morphology contains carboxylic groups.

4. The foam, according to claim 1, wherein the oxidized cellulose with fibrillar morphology is from at least one natural source selected from the group comprising eucalyptus, sugar cane bagasse and mixtures of these sources.

5. The foam, according to claim 1, comprising a concentration of natural rubber latex in dry mass between 5 and 50%.

6. The foam, according to claim 1, comprising natural rubber latex with a pH between 7 and 9.

7. The foam, according to claim 1, comprising natural rubber latex originating from Hevea brasilienses.

8. A foam production process for producing the foam of claim 1, comprising:
adding cellulose with fibrillar morphology, previously oxidized and homogenized, to a dispersion of natural rubber latex;
stirring the mixture mechanically to homogenize;
filling molds with the mixture;
freezing the mixture in the mold at −10° C. for a period between 18 and 30 hours;
freeze-drying the mixture at 10 mBar and a temperature of −45° C., for a period between 24 and 48 hours.

9. The process, according to claim 8, wherein at least one of the mold walls has lower thermal conductivity than the other mold walls.

10. The foam according to claim 1, wherein the foam is combined with dye for dye adsorption.

11. The foam, according to claim 1, wherein the foam is combined with detergents for adsorption of the detergents.

12. The foam, according to claim 1, wherein the foam is combined with inorganic precursor salts of heavy metals for adsorption of the inorganic precursor salts of heavy metals.

13. The foam, according to claim 1, wherein the foam is combined with water for decontamination and remediation of the water.

14. The foam, according to claim 1, wherein the foam is combined with organic matter and heavy metals for simultaneous adsorption of the organic matter and the heavy metals.

15. The foam, according to claim 1, wherein the heavy metals comprise Cu (II) ions.
